(19) United States
(12) Patent Application Publication
(10) Pub. No.: US 2025/0155902 A1
(43) Pub. Date: May 15, 2025

(54) GAS SENSING LEAK MITIGATION UNIT

(71) Applicant: Danfoss A/S, Nordborg (DK)

(72) Inventors: Mark Eric Miller, Nordborg (DK); Wayne Edgar Alphonso, Nordborg (DK)

(21) Appl. No.: 18/505,565

(22) Filed: Nov. 9, 2023

(51) Int. Cl. G05D 7/06; F24D 19/10

(52) U.S. Cl. CPC G05D 7/0676; F24D 19/1084; F25B 2500/221

(57) ABSTRACT

A gas sensing leak mitigation unit for a gas system includes a gas sensing element, at least one onboard relay, and at least one microcontroller. The at least one microcontroller is configured to receive a signal from the gas sensing element and to determine if the signal from the gas sensing element is above a first predetermined threshold level. The at least one microcontroller is further configured to control the energizing and de-energizing of the onboard relays. A first onboard relay may be configured, when energized, to transmit power to a compressor of the gas system and, when de-energized, to break power to the compressor. A second onboard relay may be configured, when de-energized, to transmit power to a fan control. The gas sensing element, the at least one onboard relay and the at least one microcontroller may all be arranged within a common housing.

### TECHNICAL FIELD

The disclosure relates to the field of gas sensors for detecting leaks in air conditioning systems, refrigeration systems, furnaces or other combustion systems, heat pumps, etc. This disclosure also relates to the field of leak mitigating controllers for air conditioning systems, refrigeration systems, furnaces or other combustion systems, heat pumps, etc.

### BACKGROUND

When HVAC or other refrigeration systems use refrigerants exhibiting lower global warming potential (GWP), flammability or toxicity hazards may occur in case of refrigerant leak. This is also true even when using lower toxic or mildly flammable (A2L) refrigerants, such as R32 or R1234ze/yf, or blends such as R454, for example. Mildly flammable refrigerants have an increased potential to burn as their concentration increases. Thus, the incorporation of a refrigerant leak detection mechanism into such systems has become mandatory for safety reasons.

A refrigerant gas leak sensor may be incorporated into a HVAC system or other refrigerant system and when a leak is detected by the refrigerant gas leak sensor, the HVAC system's controller may take measures to mitigate the leak and/or reduce the likelihood of toxic exposure or potential for combustion of the leaked refrigerant. Similarly, a gas leak sensor may be incorporated into a furnace or other combustion system and when a leak is detected by the gas leak sensor, the furnace or other combustion system's controller may take measures to mitigate the leak and/or reduce the likelihood of toxic exposure or potential for combustion of the leaked gas. These and other gas systems which are subject to potential leakage, and which are slated for gas leakage mitigation measures, whether for safety reasons or for preventing leakage of a gas resource, may hereinafter be referred to as gas supplied systems (GSS).

The current industry solution for mitigating gas leaks in HVAC systems uses two different units. The first is a dedicated gas sensor unit that outputs the level of gas sensed in the system to a system controller. The second is a dedicated leak mitigation control unit that has the relays needed to control the HVAC system that it is connected to. When there is a gas leak detected by the system controller, based on the signal received from the gas sensor unit, the system controller activates the dedicated leak mitigation control unit. The mitigation control unit then controls the operation of the various components of the HVAC systems to mitigate and/or stop the leak. For example, KR2001-0037406 discloses an exhaust fan control apparatus for an over-the-range microwave oven. Specifically, a signal from the gas sensor is input to a microcomputer. The microcomputer then controls first relay and second relays so as to operate an on/off power switch to an exhaust fan motor at either a high or low fan speed.

### SUMMARY

According to a first aspect, a gas sensing leak mitigation unit for a gas system may be provided wherein the gas sensing leak mitigation unit may include a gas sensing element, one or more microcontrollers, and a first relay. The microcontrollers may be configured to receive a signal from the gas sensing element and to determine if the signal from the gas sensing element is above a first predetermined threshold level. The first relay may be configured, when energized, to transmit power to a compressor and, when de-energized, to break power to the compressor. The one or more microcontrollers may also be configured to control the energizing and de-energizing of the first relay. The gas sensing element, the one or more microcontrollers, and the first relay may all be arranged within a common housing.

According to another aspect, a gas sensing leak mitigation unit for a gas system may be provided wherein the gas sensing leak mitigation unit includes a gas sensing element and first and second relays. The first relay may be configured, when energized, to transmit power to a compressor and, when de-energized, to break power to the compressor. The second relay may be configured, when de-energized, to transmit power to a fan control. The gas sensing leak mitigation unit may further include at least one microcontroller configured to receive a signal from the gas sensing element and to determine if the signal from the gas sensing element is above a first predetermined threshold level. The at least one microcontroller may be further configured to control the energizing and de-energizing of the first and second relays. The gas sensing element, the at least one microcontroller, and the first and second relays may all be arranged within a common housing.

The one or more microcontrollers may be configured to transmit an alarm condition signal to a system controller, the system controller being configured to control the gas system, when the one or more microcontrollers determine that the signal from the gas sensing element is above a first predetermined threshold level.

The one or more microcontrollers may be configured to transmit an alarm condition signal to a system controller, the system controller being configured to control the gas system, when the one or more microcontrollers determine that the signal from the gas sensing element is above a first predetermined threshold level.

The one or more microcontrollers may be configured to energize the first relay to thereby transmit electrical power to the compressor during a normal operating condition of the system. Further, the one or more microcontrollers may be configured to de-energize the first relay to thereby break the transmission of electrical power to the compressor when the one or more microcontrollers determine that the signal from the gas sensing element is above the first predetermined threshold level.

The one or more microcontrollers may be configured to control the energizing and de-energizing of the second relay. The second relay may be configured, when de-energized, to transmit power to a fan controller. The one or more microcontrollers may be configured to de-energize the second relay when the signal from the gas sensing element is above the first predetermined threshold level.

The one or more microcontrollers may be configured to receive a signal from the gas sensing element and to determine if the signal from the gas sensing element is below a second predetermined threshold level. The second predetermined threshold level may be less than or equal to the first predetermined threshold level. Further, the one or more microcontrollers may be configured to start a predetermined time delay countdown when the one or more microcontrollers determine that the signal from the gas sensing element is below the second predetermined threshold level.

The one or more microcontrollers may be configured to keep the one or more of the relays de-energized during a predetermined time delay countdown. The one or more microcontrollers may be configured to energize the one or more relays when the predetermined time delay has elapsed.

According to other aspects, the gas sensing leak mitigation unit may be incorporated into a heat pump or into a gas furnace.

### BRIEF DESCRIPTION OF THE DRAWINGS

Example embodiments of the present invention will now be illustrated with reference to the following Figures.

FIG. 1A is schematic wiring diagram illustrating an embodiment of a gas sensing leak mitigation unit in accordance with an aspect of the present invention, wherein the gas sensing leak mitigation unit may be integrated into a single stage heat pump system including a compressor, a fan and auxiliary heat control and a thermostat.

FIG. 1B-1 is a schematic wiring diagram illustrating an embodiment of a gas sensing leak mitigation unit in accordance with an aspect of the present invention, wherein the gas sensing leak mitigation unit may be integrated into a two-stage heat pump system including a compressor, a fan and auxiliary heat control and a thermostat.

FIG. 1B-2 is a schematic wiring diagram illustrating an alternative embodiment of a gas sensing leak mitigation unit in accordance with an aspect of the present invention, wherein the gas sensing leak mitigation unit may be integrated into a two-stage heat pump system including a compressor, a fan and auxiliary heat control and a thermostat.

FIG. 1C is a schematic wiring diagram illustrating an embodiment of a gas sensing leak mitigation unit in accordance with an aspect of the present invention, wherein the gas sensing leak mitigation unit may be integrated into a gas heat with cooling system including a compressor, a fan and gas furnace control and a thermostat.

FIG. 1D is schematic diagram illustrating an embodiment of a gas sensing leak mitigation unit integrated into a gas system.

FIG. 2 is a top perspective view of an embodiment of a gas sensing leak mitigation unit in accordance with an aspect of the present invention.

FIG. 3 is an exploded top perspective view of the gas sensing leak mitigation unit as shown in FIG. 2.

FIG. 4 is an exploded bottom perspective view of the gas sensing leak mitigation unit as shown in FIG. 2.

FIG. 5 is a top perspective view of a bottom part having a printed circuit board mounted thereto of the gas sensing leak mitigation unit as shown in FIG. 2.

FIG. 6 is a bottom perspective view of the printed circuit board of the gas sensing leak mitigation unit as shown in FIG. 5.

FIG. 7 is a bottom perspective view of the bottom part of the gas sensing leak mitigation unit as shown in FIG. 2.

The scope of the present invention is not limited to the above schematic drawings, the number of constituting components, the relative arrangement thereof, etc. These drawings are disclosed simply as examples of embodiments.

### DETAILED DESCRIPTION

With the advent of the use of moderate-to-low GWP refrigerants, such as A2L, the use of refrigerant gas sensors for detecting refrigerant gas leaks has become mandatory for indoor units of heating, ventilating, and air-conditioning (HVAC) systems for safety reasons. Further, when using moderate-to-low GWP refrigerants certain UL safety requirements must be met.

Preferably, such refrigerant gas sensors are installed within the air handling units of the HVAC systems, e.g., in indoor units of residential HVAC systems. Such units typically include heat exchangers and fans, and leaking of refrigerant is most likely to occur and most critical within these units. Alternatively, the refrigerant gas sensors could also be arranged outside the HVAC unit enclosure, for example in air ducts of the HVAC system near the outlet of the unit.

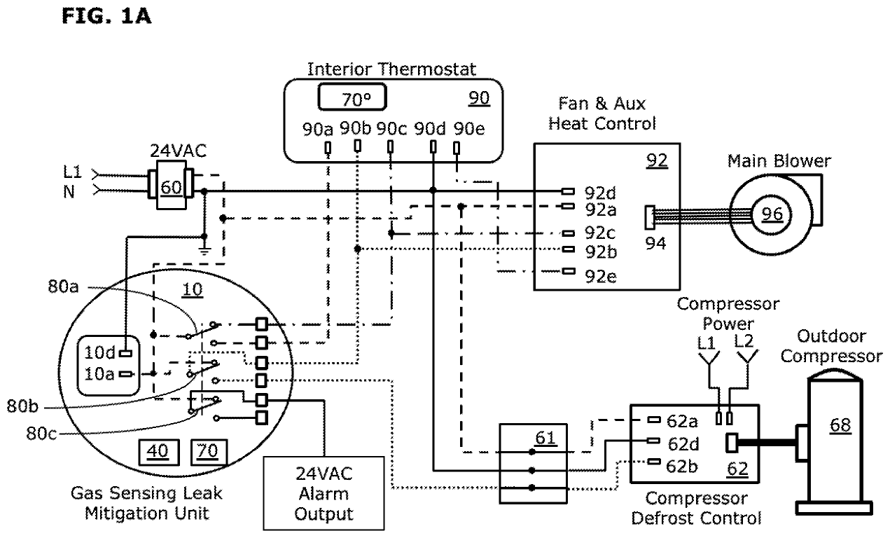

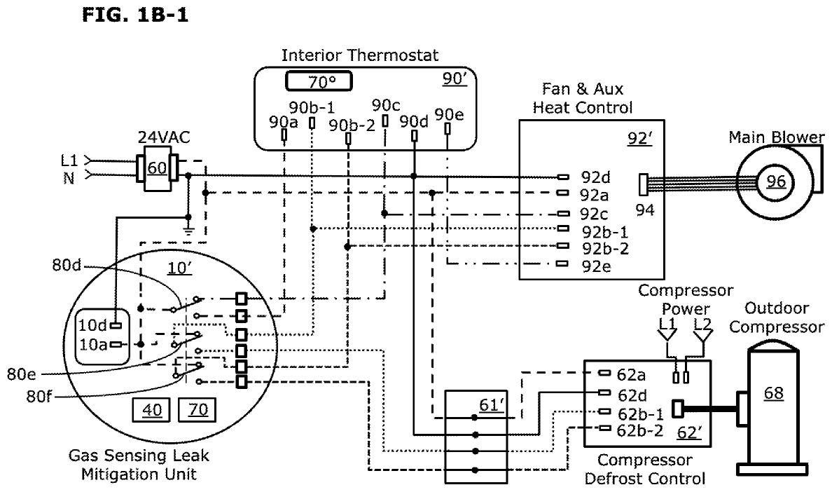

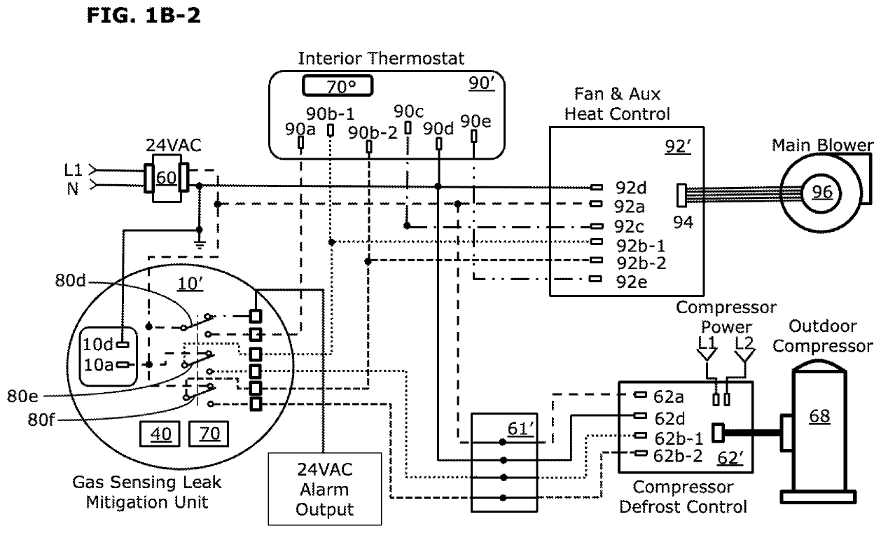

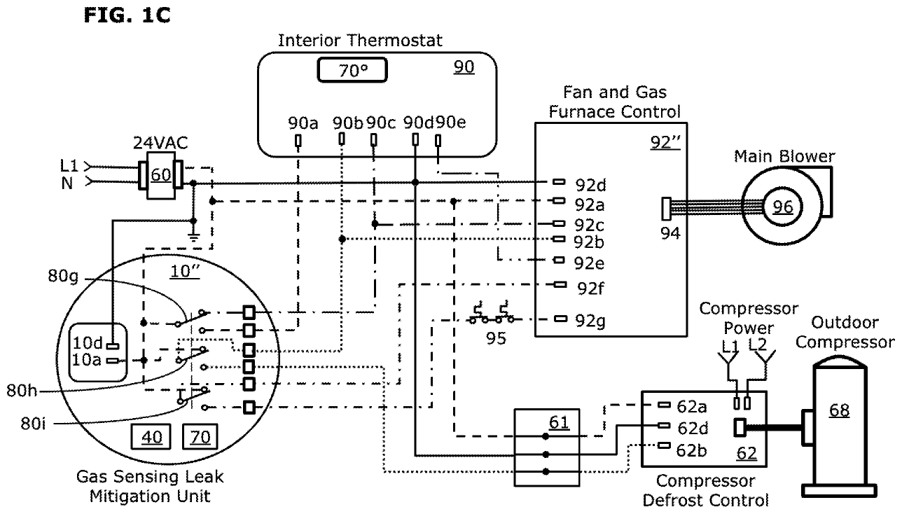

In embodiments of the present invention as best shown in FIGS. 1A-1C, a gas sensing leak mitigation unit 10 includes a gas sensing element 40, one or more onboard processors or microcontrollers 70, and one or more onboard relays 80 to activate or deactivate one or more components of the gas systems. The onboard microcontroller(s) 70 include logic for determining whether one or more operating conditions of the GSS should be implemented based on an input from a gas sensing element 40, among other inputs. The onboard microcontroller(s) 70 also include logic for controlling the onboard relays. Thus, the one or more onboard relays 80 may be activated or de-activated to control components of the GSS which are necessary to respond to an operating condition such as an alarm condition, i.e., when the level of gas sensed by the gas sensing element 40 exceeds a predetermined alarm threshold level. In a preferred embodiment, the relays are energized during normal operating conditions and are de-energized in the alarm condition.

The GSS may further include, among other things, a power supply 60, a thermostat 90, a fan control 92 with an associated fan or blower 96, and a compressor 68 with an associated compressor defrost controller 62.

In certain embodiments, one or more microcontrollers 70 are configured to process the raw gas sensor signal and produce a readable gas level output. The same, or a second, microcontroller 70 reads the gas level and compares it to a predetermined threshold. If the gas level exceeds the predetermined threshold, then an alarm condition exists. The microcontroller 70 then initiates a mitigation response. The mitigation response may include disabling a compressor 68, turning off any other heating elements (such as auxiliary heat elements) (not shown) and/or turning on a circulating fan or blower 96. The microcontroller 70 may keep the system in the mitigation response state until the alarm condition subsides. Additionally, the microcontroller 70 may keep the system in the mitigation response state until a minimum mitigation time period has ended.

For example, still referring to FIGS. 1A-1C, when the gas sensing leak mitigation unit 10 indicates an alarm condition, the one or more microcontrollers 70 may instruct a first onboard relay 80a to break or open the signal wire that instructs a compressor (or compressors) 68 to operate. In addition, the microcontroller 70 may instruct a second onboard relay 80b to now provide a signal to the system's fan control 92 to thereby turn on the fan (or blowers) 96.

The gas sensing leak mitigation unit 10 may maintain this mitigation response state until the level of gas being detected by the gas sensing element 40 falls below the predetermined alarm threshold level or below a predetermined restart threshold level (which predetermined restart threshold level may be lower than the predetermined alarm threshold level). Optionally, gas sensing leak mitigation unit 10 may maintain this mitigation state until a predetermined amount of time has passed after the level of gas being detected by the gas sensing element 40 falls below the predetermined alarm threshold level or below the predetermined restart threshold level.

By incorporating the gas sensing element 10 with one or more onboard microcontrollers 70 configured to process a gas sensor signal, to compare the gas sensor signal to a predetermined threshold, to indicate an alarm condition exists and to initiate a mitigation response, and by further incorporating one or more relays 80a, 80b and providing the one or more microcontrollers 70 with a mitigation response logic associated with the functioning of the relays 80 into a single gas sensing leak mitigation unit 10, the mitigating functions and control logic required for detecting and responding to a gas leak can advantageously be performed by a single device. Further, by using the systems 24 VAC power supply and signals, the gas sensing leak mitigation unit 10 can be added to an existing GSS with only minor changes to the wiring being required.

By integrating the gas sensing element 10 with the mitigation function, there may be a significant cost reduction. This is manifested not only in the material cost for the sensor but also with installation and other material costs for the customer. Further, by integrating the sensing and mitigation functions, the system can respond faster to alarm conditions, adjustments such as alarm levels can be changed on a single device, and the consolidated hardware is a significant cost savings to the customer.

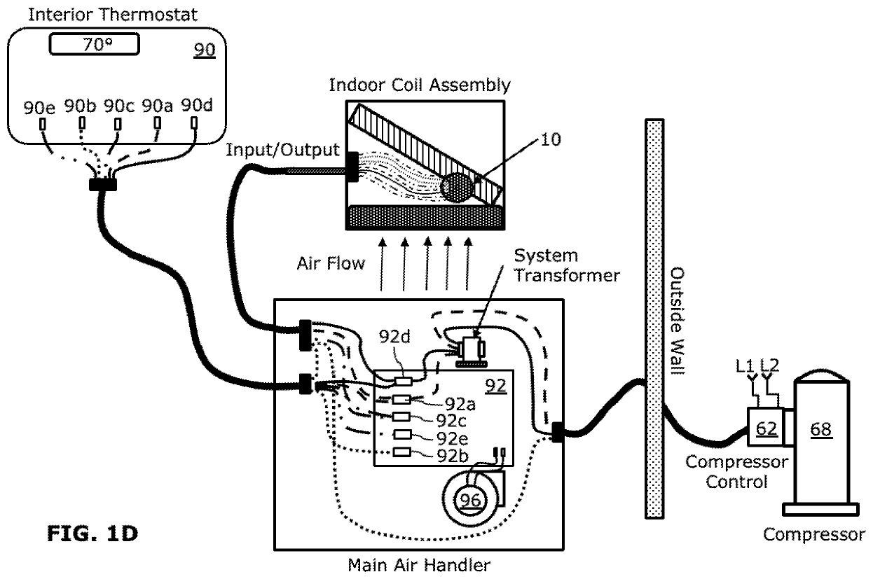

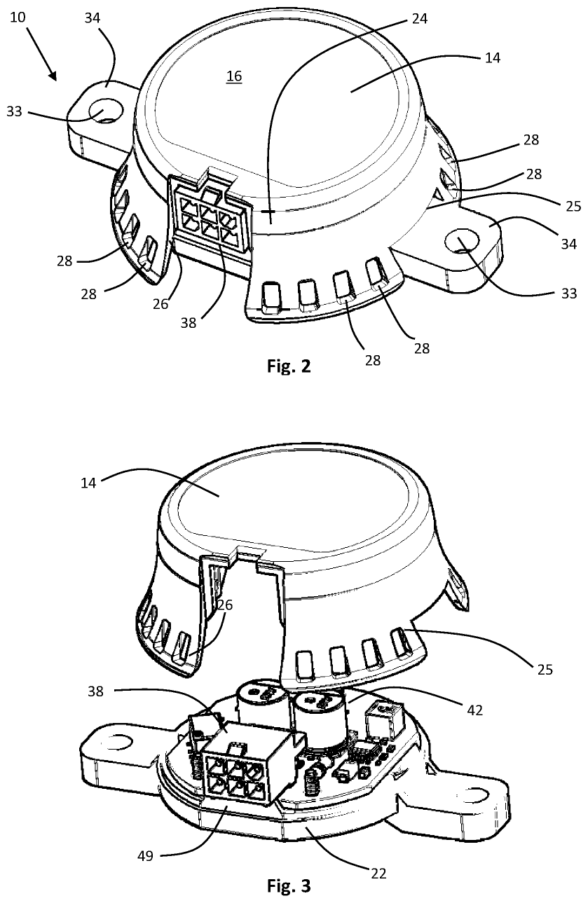

FIGS. 1A-1C each schematically show a gas sensing leak mitigation unit 10 integrated into a GSS according to the embodiments of the present invention. FIG. 1A shows gas sensing leak mitigation unit 10 integrated into a single stage heat pump application. FIGS. 1B-1 and 1B-2 show gas sensing leak mitigation unit 10 integrated into a two-stage heat pump application. FIG. 1C shows gas sensing leak mitigation unit 10 integrated into a gas heat with cooling application.

In the specific single stage heat pump example embodiment shown in FIG. 1A, gas sensing leak mitigation unit 10 is powered by a power supply 60, e.g., a 24 VAC supply. Thus, gas sensing leak mitigation unit 10 may be provided with a common ground connection 10d and a power supply connection 10a. The power supply 60 may also directly supply power to the fan/auxiliary heat control 92 and the compressor defrost controller 62. The power supply 60 may also indirectly supply power, via a relay 80 as described below, to the thermostat 90.

Thermostat 90 may include a plurality of connections, including a power supply connection 90a, a compressor on/off connection 90b, a manual fan connection 90c, a common ground connection 90d, and an auxiliary heat connection 90e.

Fan/auxiliary heat control 92 may include a plurality of connections, including a power supply IN connection 92a, a compressor IN connection 92b, a manual fan control connection 92c, a common ground connection 92d, and an auxiliary heat connection 92e. Fan/auxiliary heat control 92 may also include connections 94 to the one or more fans or blowers 96 and connections (not shown) to the one or more auxiliary heat elements (not shown). The auxiliary heat connection 92e of fan/auxiliary heat control 92 may be connected to the auxiliary heat connection 90e of thermostat 90.

Compressor defrost controller 62 may include a power supply connection 62a, a common ground connection 62d and a compressor on/off connection 62b. The compressor 68, itself, may be powered by a separate compressor power supply. An optional connector 61, e.g., for an outdoor unit, may be provided between the gas sensing leak mitigation unit 10 (and the thermostat 90) and the compressor defrost controller 62.

Still referring to the embodiment of FIG. 1A, gas sensing leak mitigation unit 10 includes a plurality of relays 80.

The common or input terminal of a first relay 80a is connected to a power line from the power supply 60. A first contact terminal of the first relay 80a is associated with the power supply connection 90a of thermostat 90. A second contact terminal of the first relay 80a is associated with the manual fan connection 90c of thermostat 90 and with the manual fan control connection 92c of fan/auxiliary heat control 92. First relay 80a is normally energized. In its energized state, first relay 80a is switched to the first contact terminal of the relay, thereby transmitting power from the power supply 60 to the power supply connection 90a of thermostat 90. When an alarm condition has been met (or optionally, in the event of a power failure), first relay 80a becomes de-energized and breaks the connection between the power supply 60 and the thermostat 90. In its de-energized state (as shown in FIG. 1A), first relay 80a is switched to the second contact terminal of the relay, thereby transmitting power from the power supply 60 to the manual fan connection 90c of thermostat 90 and to the manual fan control connection 92c of fan/auxiliary heat control 92. Thus, one or more fans may be activated to mitigate the effects of the leak when the first relay 80a is de-energized.

The common terminal of the second relay 80b is connected to the compressor on/off connection 90b of thermostat 90 and with the compressor IN connection 92b of fan/auxiliary heat control 92. A first contact terminal of the second relay 80b is associated with the compressor connection 62b of compressor defrost controller 62. A second contact terminal of the second relay 80b is associated with the power supply line of the power supply 60. Second relay 80b is normally energized. In its energized state, second relay 80b is switched to the first contact terminal of the relay, thereby completing the circuit between the compressor on/off connection 90b of thermostat 90 (and the compressor IN connection 92b of fan/auxiliary heat control 92) with the compressor connection 62b of compressor defrost controller 62. As such, in its energized state, second relay 80b allows the compressor 68 to operate normally. When an alarm condition has been met (or optionally, in the event of a power failure), second relay 80b becomes de-energized and breaks the circuitry connecting the compressor connection 62b of compressor defrost controller 62 with the compressor on/off connection 90b of thermostat 90 (and the compressor IN connection 92b of fan/auxiliary heat control 92). In its de-energized state (as shown in FIG. 1A), second relay 80b is switched to the second contact terminal of the relay, thereby transmitting power from the power supply 60 to the compressor on/off connection 90b of thermostat 90 (and the compressor IN connection 92b of fan/auxiliary heat control 92).

The common terminal of the third relay 80c is connected to an optional 24 VAC alarm output. A first contact terminal of the third relay 80c is an open circuit. A second contact terminal of the third relay 80c is associated with the power supply line of the power supply 60. Third relay 80c is normally energized. In its energized state, third relay 80c is switched to the first contact terminal of the relay, thereby being an open circuit. As such, in its energized state, third relay 80c is essentially offline. When an alarm condition has been met (or optionally, in the event of a power failure), third relay 80c becomes de-energized (as shown in FIG. 1A). In its de-energized state, third relay 80c is switched to the second contact terminal of the relay, thereby transmitting power from the power supply 60 to the optional 24 VAC alarm output.

In the specific two-stage heat pump example embodiment shown in FIG. 1B-1, a gas sensing leak mitigation unit 10′ is powered by a power supply 60, e.g., a 24 VAC supply. Thus, gas sensing leak mitigation unit 10′ may be provided with a common ground connection 10d and a power supply connection 10a. The power supply 60 may also directly supply power to a fan/auxiliary heat control 92′ and a compressor defrost controller 62′. The power supply 60 may also indirectly supply power, via a relay 80 as described below, to the thermostat 90′.

Thermostat 90′ may include a plurality of connections, including a power supply connection 90a, a compressor stage-one on/off connection 90b-1, a compressor stage-two on/off connection 902, a manual fan connection 90c, a common ground connection 90d, and an auxiliary heat connection 90e.

Fan/auxiliary heat control 92′ may include a plurality of connections, including a power supply IN connection 92a, a compressor stage-one IN connection 92b-1, a compressor stage-two IN connection 92b-2, a manual fan control connection 92c, a common ground connection 92d, and an auxiliary heat connection 92e. Fan/auxiliary heat control 92′ may also include connections 94 to the one or more fans or blowers 96 and connections (not shown) to the one or more auxiliary heat elements (not shown). The auxiliary heat connection 92e of fan/auxiliary heat control 92′ may be connected to the auxiliary heat connection 90e of thermostat 90′.

Compressor defrost controller 62′ may include a power supply connection 62a, a common ground connection 62d, a compressor stage-one on/off connection 62b-1 and a compressor stage-two on/off connection 62b-2. In this embodiment, the compressor 68′ is a two-stage compressor. The compressor 68′, itself, may be powered by a separate compressor power supply. An optional connector 61′, e.g., for an outside unit, may be provided between the gas sensing leak mitigation unit 10′ (and the thermostat 90′) and the compressor defrost controller 62′.

Still referring to the embodiment of FIG. 1B-1, gas sensing leak mitigation unit 10′ includes a plurality of relays 80.

The common terminal of a first relay 80d is connected to a power line from the power supply 60. A first contact terminal of the first relay 80d is associated with the power supply connection 90a of thermostat 90′. A second contact terminal of the first relay 80d is associated with the manual fan connection 90c of thermostat 90′ and with the manual fan control connection 92c of fan/auxiliary heat control 92′.

First relay 80d is normally energized. In its energized state, first relay 80d is switched to the first contact terminal of the relay, thereby transmitting power from the power supply 60 to the power supply connection 90a of thermostat 90′. When an alarm condition has been met (or optionally, in the event of a power failure), first relay 80d becomes de-energized and breaks the connection between the power supply 60 and the thermostat 90′. In its de-energized state (as shown in FIG. 1B-1), first relay 80d is switched to the second contact terminal of the relay, thereby transmitting power from the power supply 60 to the manual fan connection 90c of thermostat 90′ and to the manual fan control connection 92c of fan/auxiliary heat control 92′. Thus, one or more fans may be activated to mitigate the effects of the leak when the first relay 80d is de-energized.

The common terminal of the second relay 80e is connected to the compressor stage-one on/off connection 90b-1 of thermostat 90′ and with the compressor stage-one IN connection 92b-1 of fan/auxiliary heat control 92′. A first contact terminal of the second relay 80e is associated with the compressor stage-one connection 62b-1 of compressor defrost controller 62′. A second contact terminal of the second relay 80e is associated with the power supply line of the power supply 60. Second relay 80e is normally energized. In its energized state, second relay 80d is switched to the first contact terminal of the relay, thereby completing the circuit between the compressor stage-one on/off connection 90b-1 of thermostat 90′ (and the compressor stage-one IN connection 92b-1 of fan/auxiliary heat control 92′) with the compressor stage-one connection 62b-1 of compressor defrost controller 62′. As such, in its energized state, second relay 80e allows stage-one of the compressor 68′ to operate normally. When an alarm condition has been met (or optionally, in the event of a power failure), second relay 80e becomes de-energized and breaks the circuitry connecting the compressor stage-one connection 62b-1 of compressor defrost controller 62′ with the compressor stage-one on/off connection 90b-1 of thermostat 90′ (and the compressor stage-one IN connection 92b-1 of fan/auxiliary heat control 92′). In its de-energized state (as shown in FIG. 1B-1), second relay 80e is switched to the second contact terminal of the relay, thereby transmitting power from the power supply 60 to the compressor stage-one on/off connection 90b-1 of thermostat 90′ (and the compressor stage-one IN connection 92b-1 of fan/auxiliary heat control 92′).

The common terminal of the third relay 80f is connected to the compressor stage-two on/off connection 90b-2 of thermostat 90′ and with the compressor stage-two IN connection 92b-2 of fan/auxiliary heat control 92′. A first contact terminal of the third relay 80f is associated with the compressor stage-two connection 62b-2 of compressor defrost controller 62′. A second contact terminal of the third relay 80f is associated with the power supply line of the power supply 60. Third relay 80e is normally energized. In its energized state, third relay 80f is switched to the first contact terminal of the relay, thereby completing the circuit between the compressor stage-two on/off connection 90b-2 of thermostat 90′ (and the compressor stage-two IN connection 92b-2 of fan/auxiliary heat control 92′) with the compressor stage-two connection 62b-2 of compressor defrost controller 62′. As such, in its energized state, third relay 80f allows stage-two of the compressor 68′ to operate normally. When an alarm condition has been met (or optionally, in the event of a power failure), third relay 80f becomes de-energized and breaks the circuitry connecting the compressor stage-two connection 62b-2 of compressor defrost controller 62′ with the compressor stage-two on/off connection 90b-2 of thermostat 90′ (and the compressor stage-two IN connection 92b-2 of fan/auxiliary heat control 92′). In its de-energized state (as shown in FIG. 1B-1), third relay 80f is switched to the second contact terminal of the relay, thereby transmitting power from the power supply 60 to the compressor stage-two on/off connection 90b-2 of thermostat 90′ (and the compressor stage-two IN connection 92b-2 of fan/auxiliary heat control 92′).

The specific two-stage heat pump example embodiment shown in FIG. 1B-2 is similar to that shown in FIG. 1B-1, with the exception that the second contact terminal of the first relay 80d is no longer associated with the manual fan connection 90c of thermostat 90′ and with the manual fan control connection 92c of fan/auxiliary heat control 92′. Instead, the second contact terminal of the first relay 80d may be associated with a 24 VAC alarm output. Thus, according to the embodiment of FIG. 1B-2, when the first relay 80d is de-energized, power from the power supply 60 is transmitted to the 24 VAC alarm output. FIGS. 1B-1 and 1B-2 show that the manual fan may not be used if the 24 VAC alarm output is used.

In the specific example embodiment of a gas heat with cooling system shown in FIG. 1C, gas sensing leak mitigation unit 10″ is powered by a power supply 60, e.g., a 24 VAC supply. Thus, gas sensing leak mitigation unit 10″ may be provided with a common ground connection 10d and a power supply connection 10a. The power supply 60 may also directly supply power to a fan/gas furnace control 92″ and a compressor defrost controller 62. The power supply 60 may also indirectly supply power, via a relay 80 as described below, to the thermostat 90.

Thermostat 90 may include a plurality of connections, including a power supply connection 90a, a compressor on/off connection 90b, a manual fan connection 90c, a common ground connection 90d, and an auxiliary heat connection 90e.

Fan/gas furnace control 92″ may include a plurality of connections, including a power supply IN connection 92a, a compressor IN connection 92b, a manual fan control connection 92c, a common ground connection 92d, an auxiliary heat connection 92e, a limit-power-out connection 92f and a limit-in connection 92g. Note that one or more hi-limit or roll-out switches 95 may be provided in the limit-in circuitry. Fan/gas furnace control 92″ may also include connections 94 to the one or more fans or blowers 96 and connections (not shown) to the one or more auxiliary heat elements (not shown). The auxiliary heat connection 92e of fan/gas furnace control 92″ may be connected to the auxiliary heat connection 90e of thermostat 90.

Compressor defrost controller 62 may include a power supply connection 62a, a common ground connection 62d and a compressor on/off connection 62b. The compressor 68, itself, may be powered by a separate compressor power supply. An optional connector 61, e.g., for an outdoor unit, may be provided between the gas sensing leak mitigation unit 10″ (and the thermostat 90) and the compressor defrost controller 62.

Still referring to the embodiment of FIG. 1C, gas sensing leak mitigation unit 10″ includes a plurality of relays 80.

The common terminal of a first relay 80g is connected to a power line from the power supply 60. A first contact terminal of the first relay 80g is associated with the power supply connection 90a of thermostat 90. A second contact terminal of the first relay 80g is associated with the manual fan connection 90c of thermostat 90 and with the manual fan control connection 92c of fan/gas furnace control 92″. First relay 80g is normally energized. In its energized state, first relay 80g is switched to the first contact terminal of the relay, thereby transmitting power from the power supply 60 to the power supply connection 90a of thermostat 90. When an alarm condition has been met (or optionally, in the event of a power failure), first relay 80g becomes de-energized and breaks the connection between the power supply 60 and the thermostat 90. In its de-energized state (as shown in FIG. 1C), first relay 80g is switched to the second contact terminal of the relay, thereby transmitting power from the power supply 60 to the manual fan connection 90c of thermostat 90 and to the manual fan control connection 92c of fan/gas furnace control 92″. Thus, one or more fans may be activated to mitigate the effects of the leak when the first relay 80g is de-energized.

Similar to the embodiments shown in FIGS. 1B-1 and 1B-2, an alternative embodiment of a gas heat with cooling system may include a 24 VAC alarm output. As such, the second contact terminal of the first relay 80g would no longer be associated with the manual fan connection 90c of thermostat 90′ and with the manual fan control connection 92c of fan/auxiliary heat control 92′. Instead, the second contact terminal of the first relay 80g may be associated with a 24 VAC alarm output. Thus, according to an alternative embodiment of a gas heat with cooling system (not shown), when the first relay 80g is de-energized, power from the power supply 60 is transmitted to the 24 VAC alarm output. In this alternative embodiment, if the 24 VAC alarm output is used, the manual fan is not used.

The common terminal of the second relay 80h is connected to the compressor on/off connection 90b of thermostat 90 and with the compressor IN connection 92b of fan/gas furnace control 92″. A first contact terminal of the second relay 80h is associated with the compressor connection 62b of compressor defrost controller 62. A second contact terminal of the second relay 80h is associated with the power supply line of the power supply 60. Second relay 80h is normally energized. In its energized state, second relay 80h is switched to the first contact terminal of the relay, thereby completing the circuit between the compressor on/off connection 90b of thermostat 90 (and the compressor IN connection 92b of fan/gas furnace control 92″) with the compressor connection 62b of compressor defrost controller 62. As such, in its energized state, second relay 80h allows the compressor 68 to operate normally. When an alarm condition has been met (or optionally, in the event of a power failure), second relay 80h becomes de-energized and breaks the circuitry connecting the compressor connection 62b of compressor defrost controller 62 with the compressor on/off connection 90b of thermostat 90 (and the compressor IN connection 92b of fan/gas furnace control 92″). In its de-energized state (as shown in FIG. 1C), second relay 80h is switched to the second contact terminal of the relay, thereby transmitting power from the power supply 60 to the compressor on/off connection 90b of thermostat 90 (and the compressor IN connection 92b of fan/gas furnace control 92″).

The common terminal of the third relay 80i is connected to a limit-power-out connection 92f of fan/gas furnace control 92″. A first contact terminal of the third relay 80i is associated with a limit-in connection 92g of fan/gas furnace control 92″. A second contact terminal of the third relay 80i is associated with the power supply line of the power supply 60. Third relay 80i is normally energized. In its energized state, third relay 80i is switched to the first contact terminal of the relay, thereby completing the circuit between the limit-power-out connection 92f of fan/gas furnace control 92″ and the limit-in connection 92g of fan/gas furnace control 92″. As such, in its energized state, third relay 80i allows the gas furnace to operate normally. When an alarm condition has been met (or optionally, in the event of a power failure), third relay 80i becomes de-energized (as shown in FIG. 1C). In its de-energized state, third relay 80i is switched to the second contact terminal of the relay, thereby transmitting power from the power supply 60 to the limit-power-out connection 92f of fan/gas furnace control 92″. The hi-limit temperature switches 95, which may be provided in the line between the first contact terminal of third relay 80i and the limit-in connection 92g of fan/gas furnace control 92″, may break the connection should the temperature exceed a predetermined threshold.

Exemplary mitigation responses for the embodiments of FIGS. 1A-1C may include responding to the following conditions: a no-fault condition, an alarm condition, an alarm reset condition, and a delay expiration condition. In a no-fault condition, onboard relays of gas sensing leak mitigation unit 10 are energized and the GSS operates normally. In an alarm condition, the gas being sensed is detected above an alarm threshold. By way of a non-limiting example, refrigerant gas detected at a predetermined level of 18% may trigger the alarm condition. When the alarm condition is triggered, an onboard relay 80 is de-energized and the compressor may be switched off. Another onboard relay 80 may also be de-energized, switching the manual fan input of the fan control to the power supply and thereby turning the fan on. In an alarm reset condition, the gas being sensed is detected at a predetermined level below the alarm threshold. By way of a non-limiting example, the gas being sensed may be detected at a level 2.5% below the alarm threshold of 18%, e.g., refrigerant gas is detected at a level below 15.5%. A delay timer may then be started. The onboard relays 80 remain de-energized. In the delay condition, the delay timer of gas sensing leak mitigation unit 10 may count down to a predetermined delay time span end condition. By way of non-limiting examples, the delay timer may be set to expire after a 5-minute delay, a 10-minute delay, etc. When the predetermined delay time span is reached, the onboard relays 80 are re-energized, and the operation of the GSS returns to normal.

Other mitigation responses may be provided. For example, when the GSS is a refrigeration system, when an alarm condition has been triggered, gas sensing leak mitigation unit 10 may activate a circulation airflow. Gas sensing leak mitigation unit 10 may further provide an output signal notifying the system controller that mitigation activities have been activated. Activating the circulation airflow may include energizing one or more fans of the system to deliver airflow (for example, indoor airflow) at or above a predetermined minimum airflow. Activating the circulation airflow may also include energizing control signals to open one or more zoning dampers. This may include fully opening zoning dampers and/or opening any external zoning dampers. Activating the circulation airflow may also include de-energizing supplemental heat sources and/or de-energizing any other potential ignition sources. Activating the circulation airflow may include disabling compressor operation. Optionally, activating the circulation airflow may include activating a “pump down” routine in order to reduce the gas leak rate or to reduce the total amount of gas released.

As another example, relays 80 may be provided to break the demand signal from the thermostat for auxiliary heat or for other possible ignition sources. This satisfies a UL safety requirement when moderate-to-low GWP refrigerants are used.

FIG. 1D is schematic diagram illustrating an embodiment of a gas sensing leak mitigation unit integrated into a gas system. Air flows from a main air handler across an indoor coil assembly. A main blower 96 and a fan/auxiliary heat control 92 may be associated with the main air handler. An interior thermostat 90 communicates with the fan/auxiliary heat control 92. In this embodiment, gas sensing leak mitigation unit 10 is located within the indoor coil assembly and communicates with the fan/auxiliary heat control 92, the interior thermostat 90 and the compressor control 62 via one or more input/output connectors. Compressor 68 is shown located outside.

FIGS. 2 through 7 provide different perspectives of a gas sensing leak mitigation unit 10 according to an embodiment of the invention. Gas sensing leak mitigation unit 10 includes a top part 14 and a bottom part 12. Top part 14 forms an upper portion of a housing for the gas sensing leak mitigation unit 10. Bottom part 12 forms a base of the housing for the gas sensing leak mitigation unit 10.

Top part 14 includes an upper section 16 and a peripheral side section 24 attached thereto. In the embodiment shown in FIGS. 2-7, the upper section 16 is circular and generally flat, and the peripheral side section 24 includes a roughly cylindrical thin-walled upper portion and a flared, circumferential, thin-walled, skirted lower portion. A sidewall opening 26 in the peripheral side section 24 provides access to a connector 38. The lowermost region of the thin-walled, skirted lower portion includes a plurality of openings 28 arranged circumferentially. Openings 28 may be provided to facilitate flow of the gas being sensed into the interior of the gas sensing leak mitigation unit 10. The peripheral side section 24, specifically, the lowermost region of the thin-walled skirted lower portion, further includes two opposed openings 25. These two opposed openings 25 allow mounting tabs or legs 34 associated with bottom part 12 to extend beyond the circumferential, thin-walled skirted lower portion of the peripheral side section 24.

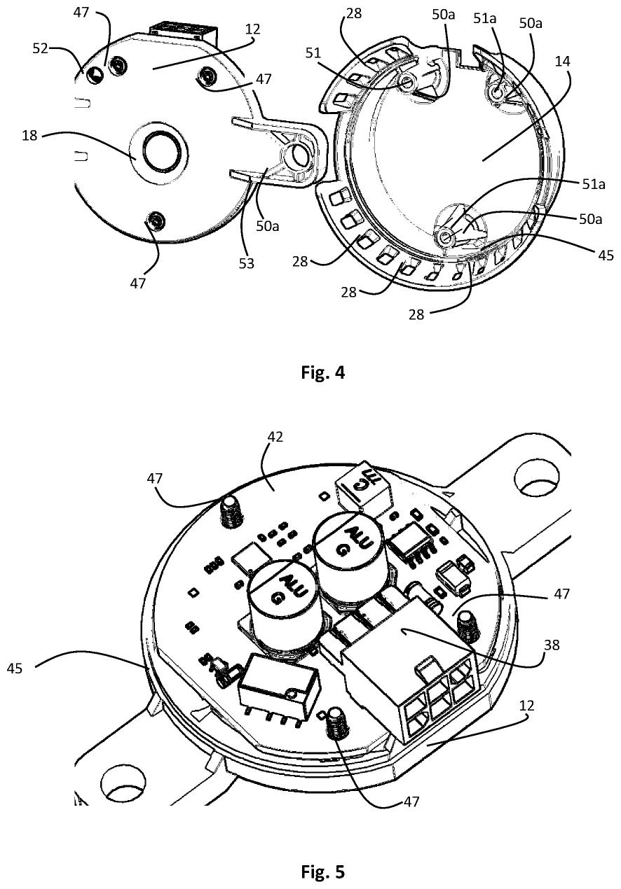

As best shown in FIGS. 2-5 and 7, bottom part 12 includes a platform 22 upon which printed circuit board assembly (PCBA) 42 is mounted. The skirted lower portion of top part 14 extends down and around platform 22 when top part 14 and lower part 12 are assembled, with the exception that mounting tabs 34 associated with bottom part 12 extend beyond the circumferential, thin-walled skirted lower portion of the peripheral side section 24 (as noted above). A hole 33 for mounting gas sensing leak mitigation unit 10 to a surface within an enclosure of the gas system is provided within each of mounting tabs 34. Further, as best shown in FIGS. 4 and 7, mounting tabs 34 may include bosses 50b, with optional ribs 51C and flange portions 53 extending around the edges of mounting tabs 34. These bosses 50b, ribs 51C and flange portions 53, which are located on the underside of mounting tabs 34, provided weight saving stiffness to mounting tabs 34 while at the same time raising platform 22 off of or above the surface to which gas sensing leak mitigation unit 10 is mounted. Raising platform 22 away from the surface to which gas sensing leak mitigation unit 10 is mounted provides a passage or channel for the gas to be sensed to flow toward opening 18. As shown in FIG. 4 and FIG. 7, opening 18 may be circular and may be positioned at the center of platform 22. Opening 18 may further be provided with a circumferential chamfer 19 for further facilitating access of the gas to be sensed to the gas sensing element 40. Other configurations, including other shapes and placements, of opening 18 and of chamfer 19 are possible, as would be apparent to a person of ordinary skill in the art given the benefit of the present disclosure. As shown in FIG. 4, bottom part 12 may also include a light guide 52 by which a light (for example, an LED) indicating that gas sensing leak mitigation unit 10 and/or gas sensing element 40 are operational may be seen. When the gas sensing leak mitigation unit 10 is mounted, the light will backlight the gas sensing leak mitigation unit 10 and will be visible by reflection from the mounting surface via the opening 28. The light may provide different information regarding the operational status, e.g., sensor power-up and self-test, normal operation, alarm state, sensor fault, etc., depending upon whether the light is blinking or its color.

In general, the housing (i.e., top part 14 and bottom part 12) for gas sensing leak mitigation unit 10 need not be any particular shape. Nor does the upper section 16 or the peripheral side section 24 need to be any particular shape or have any specific openings or opening shapes. Further, the components of the housing for the gas sensing leak mitigation unit 10 may be formed from a wide variety of materials. In a preferred embodiment, top part 14 and bottom part 12 are formed of a UV resistant material, for example, UV resistant polymers, metal coated polymers, metals, or ceramic materials, etc. Furthermore, one or more of the features of the gas sensor housing as described in U.S. patent application Ser. No. 17/836,024, filed Jun. 9, 2022, the contents of which are herein incorporated by reference in their entirety, may be implemented in the housing for gas sensing leak mitigation unit 10 as would be obvious to persons of ordinary skill in the art given the benefit of the instant application.

As best shown in FIG. 4, bosses 50a, with optional reinforcing ribs 51a, may be provided on an underside of top part 14. Referring to both FIG. 7 and FIG. 4, countersunk through holes 48 for accommodating fasteners 47 may be provided in an underside of bottom part 12. Fasteners 47 may extend through holes 48 (and also through holes in PCBA 42, see FIG. 5) and be threaded into bosses 50a to attach bottom part 12 to top part 14. A gasket 45 may be positioned within top part 14 around an interior bottom edge of the cylindrical thin-walled upper portion of top part 14. This edge with its gasket 45 contacts the upper surface of platform 22 of bottom part 12 to thereby seal the PCBA 42 within an enclosed cavity. Gasket 45 protects the PCBA and its components from being exposed to dirt and grime found in the environment surrounding gas sensing leak mitigation unit 10. Alternatively, gasket 45 may be provided on an interior upper circumferential edge of lower part 12. Further, a connector flange 49 may be provided on a top surface of platform 22 to facilitate the positioning and retention of connector 38 within the mitigation unit's housing and to prohibit dirt and grime from entering the interior of gas sensing leak mitigation unit 10.

As best shown in FIG. 5, PCBA 42 is mounted to the top surface of platform 22 of lower part 12. Connector 38 is mounted to the PCBA 42 and provides connection means to establish signal communication between gas sensing leak mitigation unit 10 and components of the GSS such as a power supply, a fan control, an ignition control, a thermostat, a compressor control, a system controller, etc. Advantageously, connector 38 is easily accessible as shown in FIG. 2.

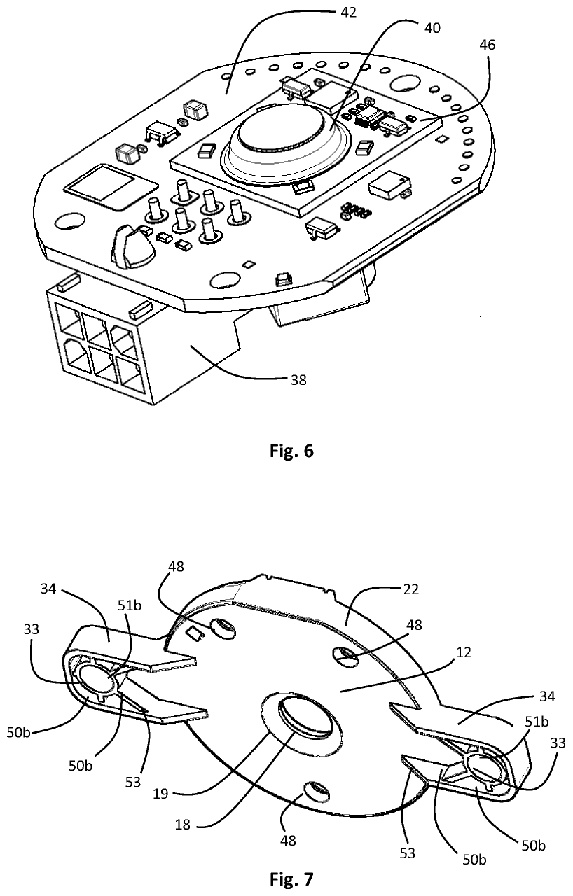

As best shown in FIG. 6, the underside of PCBA 42 has a printed circuit board 46 associated with gas sensing element 40 mounted thereto. When PCBA 42 is mounted to platform 22 of lower part 12, gas sensing element 40 is aligned with, and preferable seals, opening 18 to facilitate the gas to be sensed reaching gas sensing element 40 while prohibiting dirt and grime from entering the interior of gas sensing leak mitigation unit 10.

One or more microcontrollers 70, which are configured for signal conditioning, for determining an operational state based on an input from gas sensing element 40 and/or for implementing the mitigation logic controlling the onboard relays, may be provided on either PCBA 42 or printed circuit board 46. For purposes of this disclosure, a microcontroller is defined as a functional unit implemented using hardware, software and/or firmware. A microcontroller may be a hardware device, a software program, a firmware device, and/or a combination thereof that manages or directs the flow of data between two entities, executes code, processes signals, and/or implements programmed logic resources. Thus, the term “microcontroller” as used herein includes microcontrollers and also includes, as non-limiting examples, digital signal processors, programmable gate arrays, systems on chip (SoC), etc. As an example, a first microcontroller and a second microcontroller may reside on the same hardware, but may be implemented via separate software. As another example, all the microcontroller functions may be implemented with a single microcontroller.

Microcontrollers 70 included with the gas sensing leak mitigation unit 10 may communicate with each other and with the system controller which generally controls the operation of the GSS. System controller may receive and/or send signals from any of the sensing and/or functional components of the GSS, including gas sensing leak mitigation unit 10. Further, when a gas leak is detected, system controller may implement specific safety or leak mitigation functions including, for example, triggering an alarm, closing valves, operating fans and/or opening/closing vents. These system controller safety or leak mitigation functions may be implemented independently of, or in conjunction with, the safety and leak mitigation functions implemented by gas sensing leak mitigation unit 10.

For purposes of this disclosure, the term “relay” is meant to encompass any device or unit used for controlling the distribution path of a current. A relay may be provided as an electromechanical unit or a semiconductor device or a hybrid device. Thus, as non-limiting examples, a relay may be implemented as electrically-operated mechanical switches, optically-actuated switches, solid state relays (SSR), silicon controlled rectifiers (SCR) or thyristors, TRIACs, MOSFETs, etc.

Gas sensing leak mitigation unit 10 may be located within, or as part of, a GSS anywhere a gas sensor as known in the prior art could be located. The specific gas sensing element 40 is not limited. According to one embodiment, gas sensing element 40 may be configured for detecting a flammable or mildly flammable refrigerant. Any of a variety of gas leak sensing technologies may be used for detecting the refrigerant. Two commonly known types of gas sensors include nondispersive infrared (NDIR) gas sensing elements, which determine gas concentrations, and which are relatively expensive, and metal oxide semiconductor (MOS) gas sensing elements. Other gas sensing technologies, either for sensing refrigerants or for sensing other gases, may be employed.

It should be noted that the terms, such as “comprising,” “including” or “having,” should be understood as not excluding other elements or steps and the words “a” or “an” should be understood as not excluding plurals of the elements or steps.

While the present disclosure has been illustrated and described with respect to one or more particular embodiments thereof, it should be appreciated by those of ordinary skill in the art that various modifications to this disclosure may be made without departing from the spirit and scope of the present disclosure.

1. A gas sensing leak mitigation unit for a gas system, the gas sensing leak mitigation unit comprising:
a gas sensing element;
one or more microcontrollers configured to receive a signal from the gas sensing element and to determine if the signal from the gas sensing element is above a first predetermined threshold level;
a first relay configured, when energized, to transmit power to a compressor and, when de-energized, to break power to the compressor;
the one or more microcontrollers configured to control the energizing and de-energizing of the first relay; and
wherein the gas sensing element, the one or more microcontrollers, and the first relay are all arranged within a common housing.

2. The gas sensing leak mitigation unit according to claim 1:
wherein the one or more microcontrollers are configured to transmit an alarm condition signal to a system controller, the system controller being configured to control the gas system, when the one or more microcontrollers determine that the signal from the gas sensing element is above a first predetermined threshold level.

3. The gas sensing leak mitigation unit according to claim 1:
wherein the one or more microcontrollers are configured to energize the first relay to thereby transmit electrical power to the compressor during a normal operating condition of the system; and
wherein the one or more microcontrollers are configured to de-energize the first relay to thereby break the transmission of electrical power to the compressor when the one or more microcontrollers determine that the signal from the gas sensing element is above the first predetermined threshold level.

4. The gas sensing leak mitigation unit according to claim 1, further comprising:
a second relay configured, when de-energized, to transmit power to a fan controller;
wherein the one or more microcontrollers are configured to control the energizing and de-energizing of the second relay; and
wherein the one or more microcontrollers are configured to de-energize the second relay when the signal from the gas sensing element is above the first predetermined threshold level.

5. The gas sensing leak mitigation unit according to claim 1:
wherein the one or more microcontrollers are configured to receive a signal from the gas sensing element and to determine if the signal from the gas sensing element is below a second predetermined threshold level, which second predetermined threshold level is less than or equal to the first predetermined threshold level; and
wherein the one or more microcontrollers are configured to start a predetermined time delay countdown when the one or more microcontrollers determine that the signal from the gas sensing element is below the second predetermined threshold level.

6. The gas sensing leak mitigation unit according to claim 5:
wherein the one or more microcontrollers are configured to keep the first relay de-energized during the predetermined time delay countdown; and
wherein the one or more microcontrollers are configured to energize the first relay when the predetermined time delay has elapsed.

7. The gas sensing leak mitigation unit according to claim 4:
wherein the one or more microcontrollers are configured to receive a signal from the gas sensing element and to determine if the signal from the gas sensing element is below a second predetermined threshold level, which second predetermined threshold level is less than or equal to the first predetermined threshold level; and
wherein the one or more microcontrollers are configured to start a predetermined time delay countdown when the one or more microcontrollers determine that the signal from the gas sensing element is below the second predetermined threshold level.

8. The gas sensing leak mitigation unit according to claim 7:
wherein the one or more microcontrollers are configured to keep both the first relay and the second relay de-energized during the predetermined time delay countdown; and
wherein the one or more microcontrollers are configured to energize both the first relay and the second relay when the predetermined time delay has elapsed.

9. A gas sensing leak mitigation unit for a gas system, the gas sensing leak mitigation unit comprising:
a gas sensing element;
a first relay configured, when energized, to transmit power to a compressor and, when de-energized, to break power to the compressor;
a second relay configured, when de-energized, to transmit power to a fan control;
at least one microcontroller configured to receive a signal from the gas sensing element and to determine if the signal from the gas sensing element is above a first predetermined threshold level;
wherein the at least one microcontroller is further configured to control the energizing and de-energizing of the first and second relays;
wherein the gas sensing element, the at least one microcontroller, and the first and second relays are all arranged within a common housing.

10. The gas sensing leak mitigation unit according to claim 9:
wherein the at least one microcontroller is configured to transmit an alarm condition signal to a system controller, the system controller being configured to control the gas system, when the at least one microcontroller determines that the signal from the gas sensing element is above a first predetermined threshold level.

11. The gas sensing leak mitigation unit according to claim 9:
wherein the at least one microcontroller is configured to energize the first relay to thereby transmit electrical power to the compressor during a normal operating condition of the system; and
wherein the at least one microcontroller is further configured to de-energize the first relay to thereby break the transmission of electrical power to the compressor when the at least one microcontroller determines that the signal from the gas sensing element is above the first predetermined threshold level.

12. The gas sensing leak mitigation unit according to claim 9:
wherein the at least one microcontroller is configured to de-energize the second relay when the signal from the gas sensing element is above the first predetermined threshold level.

13. The gas sensing leak mitigation unit according to claim 9:
wherein the at least one microcontroller is configured to receive a signal from the gas sensing element and to determine if the signal from the gas sensing element is below a second predetermined threshold level, which second predetermined threshold level is less than or equal to the first predetermined threshold level; and
wherein the at least one microcontroller is configured to start a predetermined time delay countdown when the at least one microcontroller determines that the signal from the gas sensing element is below the second predetermined threshold level.

14. The gas sensing leak mitigation unit according to claim 13:
wherein the at least one microcontroller is configured to keep both the first and second relays de-energized during the predetermined time delay countdown; and
wherein the at least one microcontroller is configured to energize both the first and second relays when the predetermined time delay has elapsed.

15. A heat pump having the gas sensing leak mitigation unit according to claim 1.

16. A heat pump having the gas sensing leak mitigation unit according to claim 9.

17. A gas furnace having the gas sensing leak mitigation unit according to claim 1.

18. A gas furnace having the gas sensing leak mitigation unit according to claim 9.
